(19) United States
(12) Patent Application Publication
(10) Pub. No.: US 2011/0110841 A1
(43) Pub. Date: May 12, 2011

(54) METHOD AND APPARATUS FOR PRODUCING AMMONIUM CARBONATE FROM UREA

(75) Inventors: Richard Mahoney, Farmington, NH (US); Joanna Duncan, Springvle, ME (US); Christopher Mclarnon, Exeter, NH (US)

(73) Assignee: POWERSPAN CORP, PORTSMOUTH, NH (US)

(21) Appl. No.: 12/674,728

(22) PCT Filed: Aug. 22, 2008
(86) PCT No.: PCT/US08/74052

§ 371 Date: Feb. 23, 2010

Related U.S. Application Data
(60) Provisional application No. 60/957,773, filed on Aug. 24, 2007.

(51) Int. Cl. C01C 1/26; B01J 8/00

(52) U.S. Cl. 423/420; 422/162

(57) ABSTRACT

A method for producing ammonium carbonate from urea having the steps of providing a urea solution; hydrolyzing the urea solution to produce NH₃, CO₂ and water vapor at a chosen temperature; contacting the NH₃, CO₂ and water vapor with an ammonium carbonate solution; and maintaining the concentration of ammonium carbonate between 5 and 30% by weight by adding water to the solution.

### BACKGROUND

1. Field of the Invention

The invention relates to methods and apparatuses for making ammonia solutions for use in flue gas scrubbing.

2. Description of the Related Art

In flue gas scrubbing processes that utilize ammonia, large quantities of anhydrous or aqueous ammonia storage is required. This storage presents problems for some utilities for permitting due to the hazardous nature of ammonia. Since urea has minimal hazards associated with it, it is a preferred chemical to store in large quantities on site. For SCR applications, urea is decomposed to NH₃ and CO₂ and injected upstream of the catalyst in the gaseous form as shown in equation 1.

NH₂CONH₂+H₂O→CO₂+NH₃ (1)

It is desirable to use this approach for scrubbing systems. However the NH₃ must be injected in an aqueous form for the most efficient use rather than the gaseous form produced using traditional ammonia on demand systems. What is required, therefore, is a method and apparatus that hydrolyzes urea to form an ammonium carbonate solution to be used as a replacement for ammonium hydroxide in flue gas scrubbing.

### SUMMARY

The invention is a method and apparatus that satisfies the need to hydrolyze urea to form an ammonium carbonate solution to be used as a replacement for ammonium hydroxide in flue gas scrubbing. Method 1 according to the present invention comprises the steps of providing a urea solution; hydrolyzing the urea solution to produce NH₃, CO₂ and water vapor at a chosen temperature; contacting the NH₃, CO₂ and water vapor with an ammonium carbonate solution; and maintaining the concentration of ammonium carbonate between 5 and 30% by weight by adding water to the solution. Method 2 according to the present invention comprises the steps of providing a urea solution; and hydrolyzing the urea solution in the liquid phase to create an ammonium carbonate solution between 5 and 30%. An apparatus according to the present invention comprises a tank of urea solution; coupled with a urea hydrolyser having a means for controlling hydrolyser pressure; coupled with an ammonium carbonate tank having a water make-up means. These and other features, aspects, and advantages of the present invention will become better understood with regard to the following description, claim, and accompanying drawings.

### DRAWINGS

FIG. 1 is a process flow chart of the methods of the present invention.

FIG. 2 is a schematic showing a sample apparatus of the present invention.

### DESCRIPTION

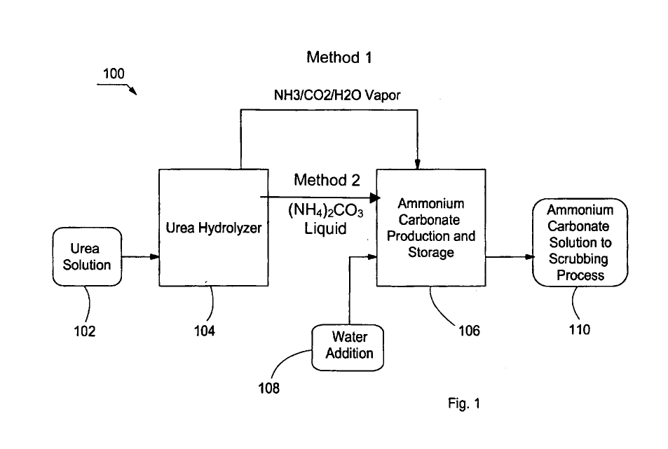

The invention is a method and apparatus that teaches how a urea solution is hydrolyzed and captured to form an ammonium carbonate solution, as well as how the system is controlled to maintain the performance of an ammonia scrubber. FIG. 1 shows a process 100 according to the present invention. A urea solution 102 is provided in the range of 10-60% by weight of urea.

In method 1, the urea is heated in a closed vessel, hydrolyzer 104. As the urea solution is heated the urea decomposes and releases CO₂, NH₃, and water vapor. The vapor stream is released from the hydrolyzer vessel and contacted 106 with water in an ammonium carbonate solution tank. The CO₂, NH₃, and water vapor condense and react to generate additional ammonium carbonate solution. As the ammonium carbonate solution is removed from the ammonium carbonate tank to be used in a process as ammonia, the pressure control valve on the hydrolyzer opens to release more vapor to replace the ammonium carbonate that was used. Opening the valve decreases the pressure in the hydrolyzer. As the pressure decreases, heat input increases to decompose more urea and generate additional CO₂, NH₃, and water vapor. Water is added 108 to the ammonium carbonate tank to maintain the desired concentration by monitoring the specific gravity or conductivity of the. It is desirable to maintain the concentration of ammonium carbonate between 5 and 30 wt % so the minimum amount of water is added 108 to the ammonia scrubbing process.

In method 2, the urea is also hydrolyzed in a urea hydrolyser 104. In this case, as the temperature of the urea solution is increased, the pressure is maintained high enough to inhibit vaporization of the CO₂, NH₃, and water vapor. Instead the reaction proceeds in the liquid phase as shown in equation 2.

NH₂CONH₂+H₂O→(NH₄)₂CO₃ (2)

Completing the reaction in the liquid phase requires substantially less energy since no vaporization is taking place. In addition, this reaction is highly exothermic and therefore the heat generated from the conversion of urea to ammonium carbonate can sustain the decomposition of urea with minimal energy input. The rate of urea conversion in the liquid phase depends on the temperature of operation. Increasing temperature increases the rate of conversion in the range of 38-260 degrees C. (100-500 degrees F.). In this method, the initial urea concentration can be chosen to provide the desired ammonium concentration after conversion or to minimize energy, more concentrated urea solutions can be used and water can be added to the product ammonium carbonate to attain the desired ammonium carbonate concentration.

Once the ammonium carbonate solution is generated, it can be used as an ammonia substitute in processes requiring ammonia addition. For example, ammonium carbonate solution is added 110 to a process that removes SO₂ using ammonia. Ammonium carbonate is added to the solution instead of aqueous ammonia to maintain pH as required based on the desired pollutant removal percentage.

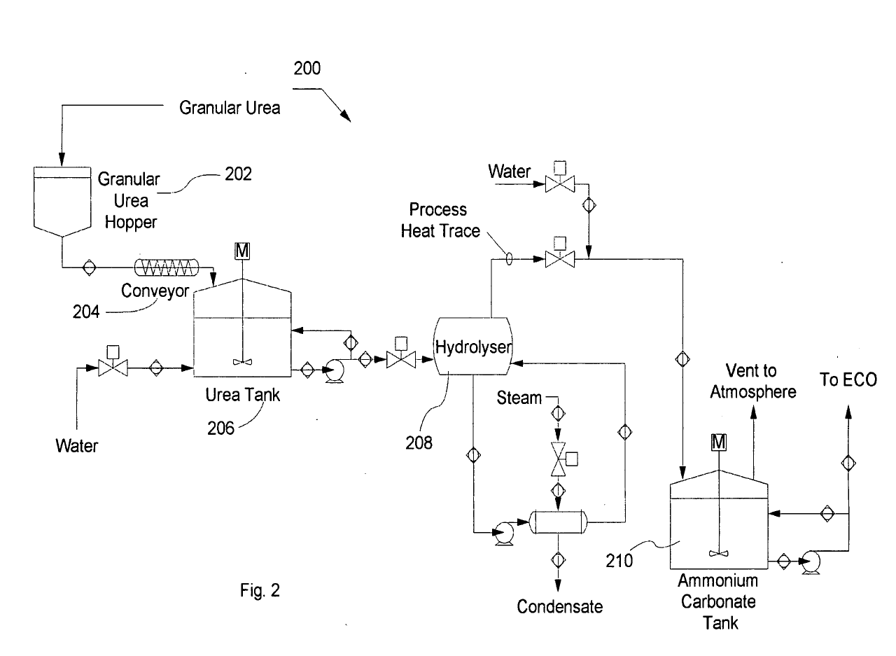

Turning to FIG. 2 the sample apparatus 200 of the present invention starts with urea in a hopper 202. The urea is fed by a conveyor 204 to a urea tank 206 where it is maintained at a concentration between 10% and 60% by weight.

The urea solution is hydrolyzed in a hydrolyser 208 to create an NH₃, CO₂, and water vapor stream (method 1) or an ammonium carbonate solution (method 2). For method 1, the vapor stream is held at elevated temperatures, meaning a temperature above that used in decomposition, until it is brought into contact with water in an ammonium carbonate solution tank 210 to prevent additional reactions from occurring which create solids in the vapor transport line. Water is added to the ammonium carbonate tank to keep the concentration of ammonium carbonate between 5% and 30% by weight. Ammonium carbonate solution is then added to an ammonia scrubbing process to maintain pH as required based on a desired percentage of pollution removal.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

1. A method for producing ammonium carbonate from urea comprising the steps of:
providing an aqueous urea solution;
hydrolyzing the aqueous urea solution in a hydrolysis step comprising the steps of producing ammonia vapor, carbon dioxide and water vapor; and cooling to condense and react the ammonia vapor, carbon dioxide, and water vapor to produce a solution of ammonium carbonate; and
maintaining the concentration of ammonium carbonate between 5 and 30% by weight by adding water to the solution of ammonium carbonate.

2. (canceled)

3. A method for supplying ammonium carbonate to a scrubbing solution for removing SO₂, comprising:
providing an aquious urea solution;
hydrolyzing the urea solution with a hydrolysis step, wherein the hydrolysis step is performed under pressure greater than ambient, thereby minimizing the formation of ammonia vapor, carbon dioxide, and water vapor, and producing a solution of ammonium carbonate; and
supplying the solution of ammonium carbonate to a scrubbing solution for removing SO₂.

4. An apparatus for producing ammonium carbonate from urea comprising:
a tank of urea solution; coupled with
a urea hydrolyzer producing ammonia vapor, carbon dioxide, and water vapor and having a means for controlling hydrolyzer pressure; coupled with a cooler to condense and react the water vapor, ammonia vapor and carbon dioxide to produce an aqueous ammonium carbonate solution; coupled with
an ammonium carbonate tank having a water make-up means.

5. An apparatus for supplying ammonium carbonate to a scrubbing process for removing SO₂, comprising:
a tank of urea solution;
a urea hydrolyzer operating at a pressure and temperature above ambient that produces an aqueous ammonium carbonate solution; and
an ammonium carbonate tank having a water make up means;
wherein
tank of urea solution is coupled with urea hydrolyzer;
urea hydrolyzer is coupled with ammonium carbonate tank; and
ammonium carbonate tank is coupled with a scrubbing process that utilizes a scrubbing solution for removing SO₂, so as to provide the ammonium carbonate solution to the scrubbing solution for removing SO₂.

6. The method of claim 1, wherein the amount of ammonia vapor, carbon dioxide, and water vapor is controlled by adjusting the pressure during the hydrolysis step.

7. The method of either of claim 1, further comprising supplying ammonium carbonate to a scrubbing process.

8. The method of either of claim 3, further comprising supplying ammonium carbonate to a scrubbing process.

9. The method of claim 7, wherein the scrubbing process is an ammonia scrubbing process.

10. The method of claim 8, wherein the scrubbing process is an ammonia scrubbing process.

11. The method of claim 7, wherein the scrubbing process removes SO₂, and the scrubbing solution for removing SO₂ comprises ammonia.

12. The method of claim 8, wherein the scrubbing process removes SO₂, and the scrubbing solution for removing SO₂ comprises ammonia.

13. The apparatus of claim 4, wherein the ammonium carbonate tank is coupled to a scrubbing process, so as to provide ammonium carbonate to the scrubbing process.

14. The apparatus of claim 5, wherein the scrubbing process is an ammonia scrubbing process.

15. The apparatus of claim 10, wherein the scrubbing process is an ammonia scrubbing process.

16. The apparatus of claim 14, wherein the scrubbing solution for removing SO₂ comprises ammonia.

17. The apparatus of claim 15, wherein the scrubbing solution for removing SO₂ comprises ammonia.
